(19) United States
(12) Patent Application Publication
(10) Pub. No.: US 2010/0227112 A1
(43) Pub. Date: Sep. 9, 2010

(54) Composite Ply with Adhered Groupings of Fiber Fasteners

(76) Inventor: Nanlin Han, Valencia, CA (US)

Correspondence Address: AARON PAUL MCGUSHION, 4565 Dogwood Ave, Seal Beach, CA, 90740, US

(21) Appl. No.: 12/698,130

(22) Filed: Feb. 1, 2010

Related U.S. Application Data
(63) Continuation-in-part of application No. 11/925,752, filed on Oct. 27, 2007, now abandoned.
(60) Provisional application No. 60/854,632, filed on Oct. 27, 2006.

(51) Int. Cl. B32B 3/06; D03D 27/00

(52) U.S. Cl. 428/92; 428/96; 428/95

(57) ABSTRACT

A composite ply is provided by the present invention, with a substrate having a plurality of fibers extending from at least one side and a plurality of fiber fasteners each being formed by the adhering together with a bonding agent of adjacent groupings of fibers. The bonding agent increases the form-holding characteristics of the fiber fasteners, such that the fastening qualities are enhanced. Advantageously, soft fiber can be stiffened to a certain level and used as fasteners that resist crushing during engagement of the fasteners. After the fastener engagement process is done, the engaged fasteners may be crushed and further interlocked when compressed within a layup with a increased compression load.

### RELATED APPLICATION DATA

This application is a continuation-in-part of co-pending U.S. application Ser. No. 11/8925,752, filed on Oct. 27, 2007, entitled “Fiber Products, Prepregs, Composites and Method of Producing Same”, which claims the benefit of U.S. provisional patent application Ser. No. 60/854,632, filed on Oct. 27, 2006.

### BACKGROUND OF THE INVENTION

1. Field of the Invention

The present invention relates to the art of composite materials, and more particularly, to a composite layer having fasteners incorporated thereon for increased delamination characteristics.

2. Description of the Related Art

Hook and loop type fasteners have been formed on the surface of material substrate sheets within the composite material industry to strengthen the inter-laminar bond between adjacent plies of the composite material to prevent delamination of the plies in this invention. The fasteners also aid in stabilizing the plies to prevent their sliding and dislocation within a wet layup during the layering, rolling, and other molding processes. Additionally, after the curing process, the fasteners increase inter-laminar strength through the mechanical interlocking of the fibers of adjacent plies.

There are some problems encountered with the use of hook and loop fasteners. Often, the fiber plies and the substrate materials are soft and pliable in nature, using such materials as fiberglass, carbon fiber, aramid, and polyester. These materials may be woven or unwoven. The fasteners may be comprised of the same soft material as the substrate or a stiffer material may be used. It is preferred with a pair of mating plies that at least one of the mating fasteners be stiff to a certain level in nature, that is, substantially holding its fastener shape and not crushing for engagement process, but the fasteners may be deformed during the high pressure of the layup and curing process. This stiffness permits the interlocking of plies rather than the mere crushing of many of the fasteners for engagement, which inhibits effective fastening and interlocking. This crushing action during engagement may also be unpredictable, interlocking in some regions and crushing (not interlocking) is other regions, creating uncertainties in strength. Even if one of the mating plies has soft fasteners, the stiff mating fasteners can effectively engage the soft fasteners and still provide a mechanical connection.

Presently, the fasteners can be made stiff by using a second stiff material interwoven or anchored to the substrate, such as metal wire, thick woven fibers, carbon rods, and the like. This, of course, often introduces a secondary process or further difficulties, adding expense and complexity to the material manufacture. Yet another method includes saturating the ply with a binder such that the soft fasteners are submerged partially or fully beneath a layer of the binder in an upright configuration, so that opposing fasteners have an increased likelihood of connecting. However, the interlocking of the opposing fasteners is very limited and crushing still a problem.

Accordingly, there has been a long-felt need in the art for a composite ply having form-holding fasteners extending therefrom which are configured to effectively engage opposing fasteners without substantial crushing during engagement. What is also needed is a composite ply that is inexpensive to manufacture. Additionally, what is needed is a composite ply with fasteners having the ability to mechanically connect non-adjacent plies.

### SUMMARY OF THE INVENTION

The present invention is directed to a composite ply with form-holding fasteners extending from therefrom that are configured to penetrate and engage the mating fasteners of another ply within a layup. The present invention permits the use of a soft fiber that is easily woven or otherwise anchored to a substrate, providing a means to stiffen the fiber to a certain level to permit effective fastening. The present invention also reduces costs and permits the fibers to be made of a similar material as the substrate.

In a preferred embodiment of the present invention a composite ply is provided comprising a substrate having a plurality of fibers extending from at least one side thereof and a plurality of fiber fasteners each being formed by the adhering together with a bonding agent of adjacent groupings of the fibers. The bonding agent increases the form-holding characteristics of the fiber fasteners, thereby enhancing their fastening qualities. There are numerous contemplated bonding agents, such as resin, adhesives, or metal, which can be applied on the surface of the fiber fasteners or may permeate the fibers of the fiber fasteners or both. The fibers may be attached to the substrate through known flocking processes. They may also be interwoven into the substrate through known weaving or knitting processes. The substrate may be a sheet material, a yarn material, or a strip material.

The term “fastener” as it is used in the specification and claims herein means a portion of the composite ply that is capable of engaging with features of another ply within the layup, through any means and including hooking, entanglement, and penetration. These fiber fasteners preferably enable the non-permanent attachment on two or more plies, such that they may be disassembled and adjusted in position, although an immediate permanent bonding may also be possible. The fiber fasteners can be shaped as either a hook, a loop, or a variation of the two. The bonding agent holds the desired shape.

One side of the substrate may be a cut pile and the opposing side may be formed into a loop or uncut pile. This can be achieved by utilizing a towel weaving process, where the loops on one side are cut, using mechanical, heat, or laser means well known in industry. The bonding agent can be selectively applied to the fiber fasteners of just one side, to just the hooks, or to just the loops. The bonding agent may be applied by dipping the fiber fasteners in the bonding agent (leaving the substrate and opposite side bare if desired), spraying the bonding agent, or brushing the bonding agent on the fiber fasteners. Other effective methods of applying the bonding agent are also permitted.

The substrate may have a variety of configurations, such as being made of two or more fiber sheets laid one on the other (plied). These fiber sheets may be bonded or mechanically fastened together by, for example, sewing, stapling, weaving, or knitting.

Two or more composite plies of the present invention may be stacked together where the fiber fasteners of adjacent plies interlock. This interlocking most usually occurs with a mold during the layup process, where the user may lay one composite ply upon another, possibly brushing on additional resin. The fiber fasteners may be further induced to interlock through rolling or compression. The layup may be vacuum bagged and heated to cure the bonding agent of the fiber fasteners, such that mating fiber fasteners or contiguous plies are permanently bonded to each other, thus enhancing the interlocking action and increasing interlaminar strength. The fiber fasteners on either ply may be hooks or loops, such that there is hook-to-hook mating or hook-to-loop mating.

In yet another composite assembly, one or more fiber articles may be interposed and sandwiched between two composite plies of the present invention. The fiber fasteners penetrate and pass through the fiber article to engage the composite ply on the opposite side of the fiber article. Or the fiber fasteners of each ply may engage a fastening feature of the fiber article and not fully penetrate. The fiber article and substrate may be selectively impregnated with one or materials, such as resin, polymer, glass, carbon, metal, or ceramic. A composite ply having multiple sheet can be made. A prepreg of the composite ply can also be made.

Hooks may also be formed in an uncut pile (loops) by the imparting of a hook shape in each loop, for example, by bending over the loops to form a hook shape, either maintaining or collapsing the hook shape. The bonding agent similarly substantially holds the hook shape.

### BRIEF DESCRIPTION OF THE SEVERAL VIEWS OF THE DRAWINGS

FIG. 1 is a cross sectional view of the preferred embodiment of the present invention, showing the fiber fastener on a substrate;

FIG. 2 is a cross sectional view of the preferred embodiment of the present invention, showing the fiber fastener on a multiple fiber sheet substrate;

FIG. 3 is a cross sectional view of the preferred embodiment of the present invention, showing two composite plies with the fiber fasteners interlocked;

FIG. 4 is a cross sectional view of the preferred embodiment of the present invention, showing a fiber article sandwiched between two substrates;

FIG. 5 is a cross sectional view of an alternate embodiment of the present invention, showing the fiber fasteners on a yarn substrate;

FIG. 6 is a cross sectional view of the preferred embodiment of the present invention, showing a loop which has been folded over to form a hook;

FIG. 7 is a side view of a flocking device; and

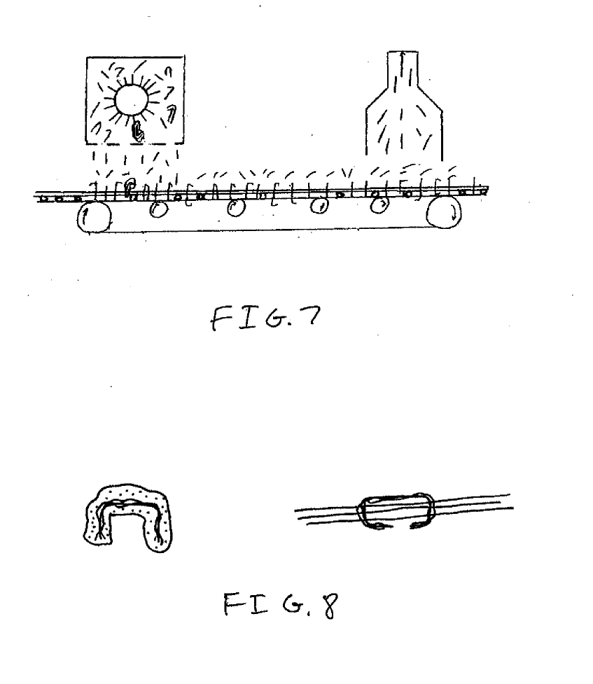

FIG. 6 is a view of a fiber staple coated with a bonding agent.

### LISTING OF REFERENCE NUMERALS OF FIRST-PREFERRED EMBODIMENT

| | |
|---|---|
| composite ply | 10 |
| substrate | 12 |
| fibers | 14 |
| first side | 16 |
| second side | 18 |
| adjacent grouping of fibers | 20 |
| bonding agent | 22 |
| fiber fastener | 24 |
| loop | 26 |
| hook | 28 |
| fiber sheet | 30 |
| fiber sheet | 32 |
| fiber sheet | 34 |
| second composite ply | 36 |
| fiber article | 38 |
| yarn substrate | 40 |

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

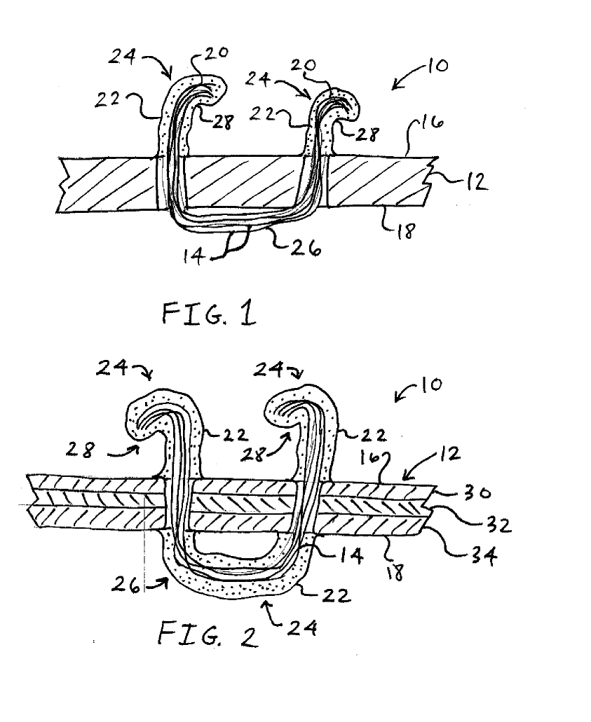

Looking first at FIG. 1, the composite ply 10 of the present invention can be seen. A substrate 12 is provided, being made of a variety of suitable woven and nonwoven materials as listed above. The processes used in the manufacture of fabrics and such, like knitting or weaving, are well known in the art and are therefore not further discussed. One method of method of weaving or inserting the fibers through the substrate could involve a towel weave process, producing a soft uncut pile on one or both sides of the substrate 12. As seen here, on the first side 16 of the substrate 12, the fibers 14 have been cut, while remaining uncut on the second side 18. Adjacent groupings of fibers 20 are adhered together with the bonding agent 22 to create the fiber fastener 24. The bonding agent 22 tends to increase the form holding characteristics of the adjacent fibers so that they substantially hold a desired shape. The adjacent grouping of fibers 20 is shown here as a single yarn woven through the substrate 12 and gathered on the first side 16 into fiber fasteners 24. This arrangement is just one possibility. When looking at cut pile, there is a high density of fibers standing on end; any adjacent fibers may be gathered and grouped into fiber fasteners 24, whether form the same yarn or not. FIG. 1, futher shows a loop 26 formed on the second side 18, which is not coated with the bonding agent 22, as only one fiber fastener 24 is a mating pair of composite plies 10 requires a higher degree of rigidity, although both mating fiber fasteners 24 may also be rigid.

FIG. 2 shows the composite ply 10 with three fiber sheets (30, 32, and 34) or more sheets comprising the substrate 12. The fiber sheet materials may be different from one layer to the next and may also be selectively impregnated with a resin or other material. Additionally, the loop 26 on the second side 18 is coated with the bonding agent 22. The fiber sheets (30, 32, and 34) may be mechanically fastened together by known means, such as stitching through two or more sheets or through a stapling or similar process.

In FIG. 3, two mating composite plies 10 and 36, one laid on top of the other, show the interlocking of their respective fiber fasteners 24. The composite is shown in the uncompressed state to more clearly demonstrate the locking features. The two composite plies 10 and 36 may be compressed in a mold while still maintaining an interlocked state.

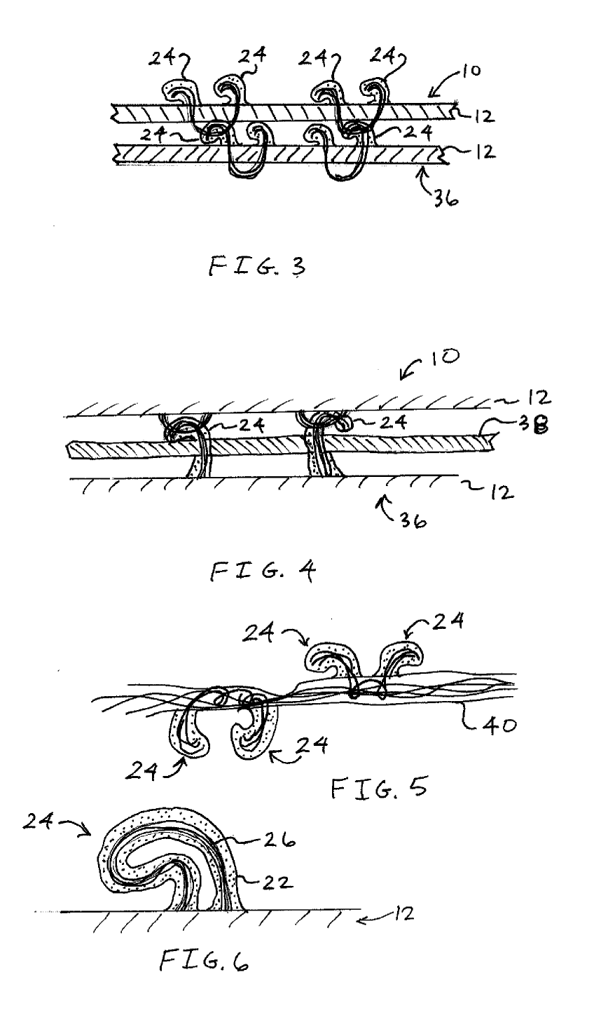

Yet another variation of the present invention can be seen in FIG. 4, showing a fiber article 38 interposed between the two fiber articles 10 and 36. The fiber fasteners 24, formed as hooks 28, are sufficiently rigid to pierce through the fiber article 38 and interlock with the loops 26 of composite ply 10.

An alternate embodiment is shown in FIG. 5, where a yarn 40 or narrow strip is used as a substrate. The fibers 14 are interwoven or anchored into the yarn 40 with the fiber fasteners 24 being similarly formed by the grouping of adjacent fibers and coating with the bonding agent 22.

To illustrate one of the many conceived configurations of the fiber fasteners 24, one can look to FIG. 6, showing a loop 26 coated with the bonding agent 22 and bent over to form a hook 28 feature. There are many known techniques for forming fastening features on a material from cut or uncut pile or other protruding material. These techniques could include the use of heat or lasers to curl, deform and cut the fibers. Additionally, chemicals may be applied to form various features. A mold may be applied to the surface of the ply to obtain specific fiber shapes. Other mechanical means may also be used to form the features, such as the application to the surface of a screw cylinder or spiral spur gear to form the hooks. Further, the fibers 14 may be applied to the substrate in many ways, including being bonded or glued on, welded, compressed, wrapped deposited, or through the growth of fibers from the substrate.

In tearing tests of the present invention, where one composite ply is pulled away from a mated and cured composite ply, it was shown that the fiber fasteners of the present invention can increase tear strength by 50 to 100%, increase compression strength by more than 20%, increase impact strength by 20%, and increase layup efficiency by 40%.

FIG. 7 shows using a flocking process and modified flocking process to prepare fastening components such as short fibers on fiber sheet or other substance surface. The substance surface may have flocked fastening components such as short fibers embed in or on the surface, which can increase the interface strength when the substance surface having flocked fastening components meets another substance surface with or without the flocked fastening components. The flocked fastening components or flocked short fibers can be transversely laid through the interface of two substance and make the interface stronger by the locked fasteners or the link of short fibers.

In FIG. 7, the flocking process involves applying fastening components such as short fibers, fiber bundles and bonded fibers directly on to the substrate that may or may not have been previously coated with an adhesive. The process uses mechanical or electrical equipment that mechanically erects or electrically charges the flock fastening components such as short fibers causing them stand-up. The fastening components are then propelled and anchored into the adhesive at near right and right angles to the substrate. The flocking process can be accomplished by one the four methods: electrostatic, beater bar/gravity, spraying and transfers. Flocking fastening component material can also be spayed using an air compressor, reservoir and spay gun similar to spaying paint. Flocking is also applied by print an adhesive on to a material, and then rapidly vibrating the substrate mechanically, while the flock fastening components such as fibers are dispensed over the surface.

An adhesive film sheet is laid beneath the fabric and particles are applied to the film to act as stand-offs to create a gap between the fabric and the film below. Then the fibers are flocked through the fabric; the gap permits the fibers to fully penetrate through the fabric, stopping at the film. The film and fabric are then later compressed, so that the gap collapses and the fibers are firmly implanted in the fabric. The vibration promotes the density of fastening components such as fibers and causes the flocking fastening components to adhere to the adhesive and pack into a layer. This process is a beater bar or gravity flocking system.

FIG. 8 shows a fiber staple using the concept of the present invention of coating soft fibers with a bonding agent to create a staple that is sufficiently rigid to staple two or more sheets together and later cured to harden to a strong fastening means.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. A composite ply comprising:
a substrate having a plurality of fibers extending from at least one side thereof; and
a plurality of fiber fasteners each being formed by the adhering together with a bonding agent of adjacent groupings of said fibers;
whereby said bonding agent increasing the form-holding characteristics of said fiber fasteners thereby enhancing fastening qualities.

2. The composite ply of claim 1 wherein each said fiber fastener is formed into one of a hook and a loop, said bonding agent facilitating the holding of desired configuration.

3. The composite ply of claim 1 wherein said fibers being formed into a cut pile on a first side and said fibers being formed into a loop pile on an opposite side thereof.

4. The composite ply of claim 3 wherein said cut pile being formed into said fiber fasteners coated with said bonding agent; said loop pile not being coated with said bonding agent.

5. The composite ply of claim 1 wherein said substrate is comprised of a plurality of fiber sheets plied contiguously.

6. The composite ply of claim 5 wherein said plurality of fabric sheets are mechanically fastened together.

7. The composite ply of claim 1 wherein a second composite ply is laid thereon, said fiber fasteners interlocking with fastening features of said second composite ply.

8. The composite ply of claim 7 wherein said bonding agent may be cured such that said fiber fasteners adhere to said fastening features to enhance interlocking.

9. The composite ply of claim 7 wherein at least one fiber article is interposed between said composite ply and said second composite ply; said fiber fasteners penetrating through said fiber article interlocking with said fastening features of said second composite ply.

10. The composite ply of claim 7 wherein said fastening features of said second fiber ply comprising one of a hook and a loop.

11. The composite ply of claim 9 wherein said fiber article is impregnated with one or more materials selected from the group consisting of resin, polymer, glass, carbon, metal, and ceramic.

12. The composite ply of claim 1 wherein said substrate is impregnated with one or more material selected from the group consisting of resin, polymer, glass, carbon, metal and ceramic.

13. The composite ply of claim 1 wherein said substrate comprising one of a yarn and a strip.

14. The composite ply of claim 5 wherein at least one said fiber sheet in said substrate is impregnated with one or more material selected from the group consisting of resin, polymer, glass, carbon, metal and ceramic.

15. The composite ply of claim 1 wherein said fibers are an uncut pile, said fiber fastener formed by the impartation of a hook features on said uncut pile, said bonding agent facilitating the holding of said hook features.
